(19) United States
(12) Patent Application Publication
(10) Pub. No.: US 2008/0306178 A1
(43) Pub. Date: Dec. 11, 2008

(54) MIXTURE FOR FABRICATING ADHESIVE ORGANIC GELS AND USE THEROF

(75) Inventor: Christophe SERBUTOVIEZ, Voiron (FR)

Correspondence Address: CANTOR COLBURN, LLP, 20 Church Street, 22nd Floor, Hartford, CT, 06103, US

(73) Assignee: COMMISSARIAT A L'ENERGIE ATOMIQUE, Paris (FR)

(21) Appl. No.: 12/110,558

(22) Filed: Apr. 28, 2008

(30) Foreign Application Priority Data
Jun. 6, 2007 (FR) 0755513

(51) Int. Cl. C08J 3/28; C08F 20/06; C08L 33/08; B29C 35/08; C08G 65/04

(52) U.S. Cl. 522/6; 526/317.1; 528/421; 524/556; 264/496

(57) ABSTRACT

The mixture according to the invention comprises:
molecules having physicochemical properties,
monomers, carrying crosslinkable functions, and representing at least 30% by weight of the mixture, advantageously at least 40% by weight.
   This mixture is used in particular in methods for fabricating and sealing crystal-containing cells or batteries, consisting of juxtaposed troughs.

### FIELD OF THE INVENTION

The present invention relates to the formulation of a mixture from molecules having physicochemical properties, in particular optical or electrolytic, for obtaining a gel having an adhesive power.

More precisely, the present invention describes this mixture and a method for obtaining such a gel.

This formulation has applications in particular for filling and sealing liquid crystal cells or batteries, which have the feature of consisting of a juxtaposition of troughs.

### PRIOR ART

No simple method is available today for filling and sealing structures consisting of juxtaposed troughs (FIG. 1). In fact, during the filling of a trough 1, the liquid, for example a liquid having optical properties 2, sometimes overflows the trough (FIG. 2A). This causes the walls separating the troughs to be polluted by this liquid. This makes it impossible to properly bond the cover 3 for sealing the troughs. FIG. 2B shows that the cover does not adhere to the wall.

Thus an obvious need exists to develop technical solutions for easily and effectively filling and sealing structures consisting of juxtaposed cells closed using a cover, such as crystal-containing cells, or batteries.

### DESCRIPTION OF THE INVENTION

The Applicant unexpectedly identified a formulation for preserving the physicochemical properties of an advantageous compound and also having an adhesive power. This formulation corresponds to an adhesive polymer gel, filled with advantageous compounds.

According to a first aspect, the invention relates to the mixture for obtaining such a gel, after curing.

A mixture according to the invention comprises:
molecules having physicochemical properties;
monomers carrying crosslinkable functions and representing at least 30% by weight of the mixture, advantageously at least 40% by weight.

The gel is formed by polymerization, thanks to the presence of the monomers carrying crosslinkable functions. The preferred crosslinkable functions according to the invention are provided by acrylic or epoxy groups. The monomers may carry one or more crosslinkable functions. According to the invention, the monomers are advantageously bi- or multifunctional.

Characteristically, the controlled mass concentration of monomers carrying crosslinkable functions in the mixture is important for obtaining the adhesive character of the gel, after curing. Thus, it has been determined in the context of the invention that a proportion of monomers carrying crosslinkable functions of at least 30% by weight, or even at least 40% of the total mixture, was appropriate.

The curing may be promoted by the presence of at least one photoinitiator in the mixture according to the invention. In this case, the curing takes place under UV radiation.

The preferred type of photoinitiator depends on the type of crosslinkable function. In the presence of acrylic groups, Irgacure 651 or lucridine TPO is preferably used. However, for epoxy functions, a compound of the photo acid generator type is advantageously incorporated with the mixture. The photoinitiator concentrations in the mixture are easily determined by a person skilled in the art, and are generally lower than 1%.

According to a first embodiment, the molecules having physicochemical properties are liquid crystals having optical properties.

It should be noted that the use of polymers for producing optical functions had already been reported in patent US 2004/0008319A1. However, this document did not describe a gel of polymers of the liquid crystal type. In fact, the materials obtained consisted of juxtaposed drops of polymers.

According to this embodiment and preferably, the monomers carrying crosslinkable functions are also liquid crystals. However, they are not necessarily all of an identical type. Such monomers are selected for example from the following list:

monofunctionalized liquid crystal molecule of the acrylic type, for example the following compound A:

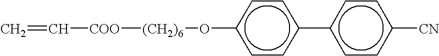

bifunctionalized liquid crystal molecule of the acrylic type, in particular the following compound B:

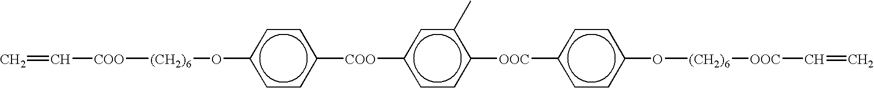

multifunctionalized (in this case hexafunctionalized) liquid crystal molecule of the acrylic type, in particular the following compound C:

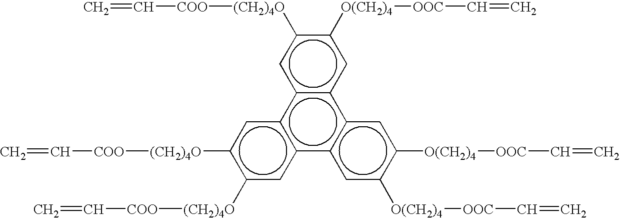

epoxy based bifunctionalized liquid crystal molecule, in particular the following compound D:

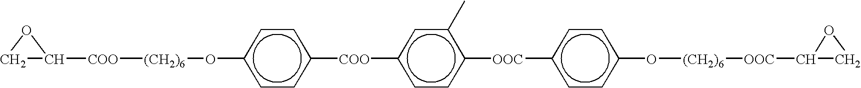

In this application, the liquid crystal monomers used are advantageously carriers of acrylic groups. The acrylic groups are further advantageously two in number per monomer, that is the monomer is advantageously bifunctionalized. Furthermore, the two crosslinkable functions are even more advantageously located at the ends of the liquid crystal molecule.

Preferably, the liquid crystal used in the mixture, both the one having optical properties and the functionalized liquid crystal, is selected from the group comprising nematic, cholesteric, smectic and ferroelectric liquid crystals.

On completion of the curing step, advantageously carried out by insolation with UV light, the reaction mixture is converted to an anisotropic gel. This is a liquid crystal gel having an adhesive power. The presence of the functionalized, advantageously multifunctionalized monomers serves to crosslink the polymer chains together and thereby ensures the cohesion of the gel. The gel is in the form of a three-dimensional network of crosslinked polymer, filled with liquid crystal.

It should be noted that anisotropic gels have already been described in the literature for their optical light modulation properties (R. A. M. HIKMET et al.). However, the typical monomer concentrations reported are about 3 to 20% by weight of the total weight of the mixture (R. A. M. HIKMET et al.; Yun-Hsing FAN et al.).

The present invention demonstrates that at monomer concentrations higher than 30% by weight of the total weight of the components (in this embodiment, essentially the unreactive liquid crystal molecules), the gel has characteristic adhesive properties on substrates such as glass and plastics, without any alteration of the optical properties of the gel.

Appropriately, the liquid crystal mixture according to the invention has a liquid crystal phase before curing.

The gel obtained after curing, placed in the troughs, can be subjected to the action of an electric field. Under this action, the materials contained in the troughs may be oriented in particular directions. This serves to adjust the intensity and/or the polarization of the incident light.

It is also possible to integrate, in the mixture according to the invention, dichroic dyes or photochromic compounds. The presence of the liquid crystal gel allows their alignment along a preferential axis. In the case of photochromic compounds, the presence of the gel further allows rapid transition of these molecules between the transparent state and the absorbent state.

In relation to this aspect, the invention also relates to a method for fabricating and sealing crystal-containing cells, consisting of juxtaposed cells.

Such a method comprises the following steps:

filling, advantageously to excess, of the troughs using a mixture as described above;

placement of a cover;

pressing;

curing of the mixture, advantageously by insolation with UV.

As already stated, such a method may comprise a subsequent step of exposure to an electric field, causing the orientation of the crystals in particular directions. This serves to adjust the intensity and/or polarization of the incident light. The conditions of this exposure are known to a person skilled in the art.

Importantly, it should be noted that when the concentration of crosslinkable liquid crystal monomers exceeds 40% by weight, it is possible to no longer use the trough structure. In this case it is the structure of the gel that ensures that sealing of the object thereby formed. In order to guarantee a constant thickness, spacers may be added to freeze the thickness of the structure.

The mixture, the gel and the method according to the invention, as described, offer other applications than optical components.

Thus, a second embodiment of the invention concerns electric batteries consisting of a juxtaposition of troughs.

This embodiment is characterized by the fact that the molecules having physicochemical properties are electrolytes of the lithium (Li) salts type, such as LiClO₄, LiCl, LiBF₄, for example, or mixtures thereof.

It clearly appears that these molecules must be soluble in the mixture according to the invention.

Advantageously, the gelification and the adhesive character of the gel are obtained using mono and/or multifunctionalized monomers using crosslinkable functions of the epoxy type, advantageously substituted by at least one hydrophilic group.

Such monomers are for example selected from the following list:

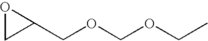

Hydrophilic molecule functionalized by an epoxy group (compound E)

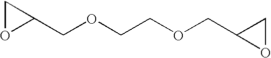

Hydrophilic molecule bifunctionalized by two epoxy groups (compound F)

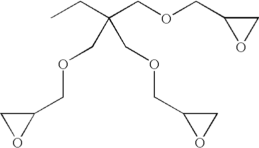

Hydrophilic molecule trifunctionalized by three epoxy groups (compound G).

In a preferred embodiment, the crosslinkable functions are two in number per monomer, and the monomers are thereby bifunctionalized.

As already stated, the monomer concentration is equal to 30% or more of the total weight of the mixture to be cured. Furthermore, when the curing is carried out by insolation with UV, a polymerization initiator of the photo acid generator type is added to the mixture according to the invention.

Another aspect of the invention therefore concerns a method for fabricating and sealing batteries consisting of juxtaposed cells.

Such a method comprises the following essential steps:

filling of the juxtaposed troughs using a mixture as previously described;

curing of the mixture, advantageously by insolation with UV;

placement of a cover.

It should be noted that in this particular application, the method must allow for the installation of the electrodes.

The anode may be placed either on the cover, or at the bottom of the trough. As to the cathode, it is placed opposite the anode.

The advantages of the present invention appear clearly from the exemplary embodiments described below, in conjunction with the appended figures. However, these exemplary embodiments are nonlimiting.

### FIGURE CAPTIONS

FIG. 1 shows a schematic cross section (A) or plan view (B) of cells consisting of juxtaposed troughs closed with a cover.

FIG. 2 shows a schematic view of troughs filled with excess liquid, before (A) and after (B) closure using a cover.

FIG. 3 shows the method for fabricating and sealing crystal-containing cells (A/ before placement of the cover; B/ after placement of the cover).

FIG. 4 shows batteries fabricated using the reaction mixture and the method according to the invention.

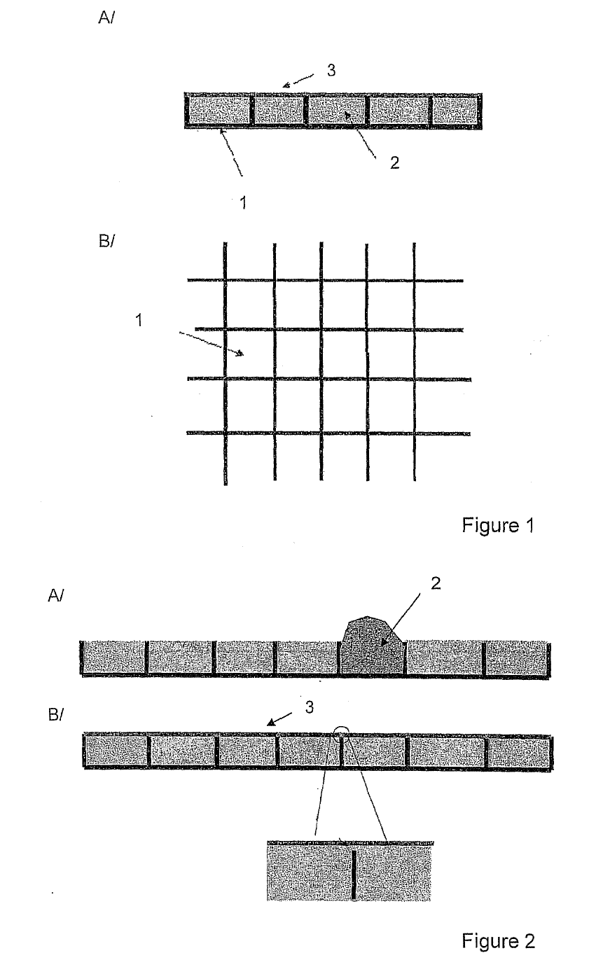

### 1/ FABRICATION OF CRYSTAL-CONTAINING CELLS

### Preparation of the Reaction Mixture:

A mixture is prepared comprising by weight:

0.5% Irgacure 651 (CIBA);

68.5% E7 (Merck) liquid crystal;

20% of compound A (as described above);

10% of compound B (as described above).

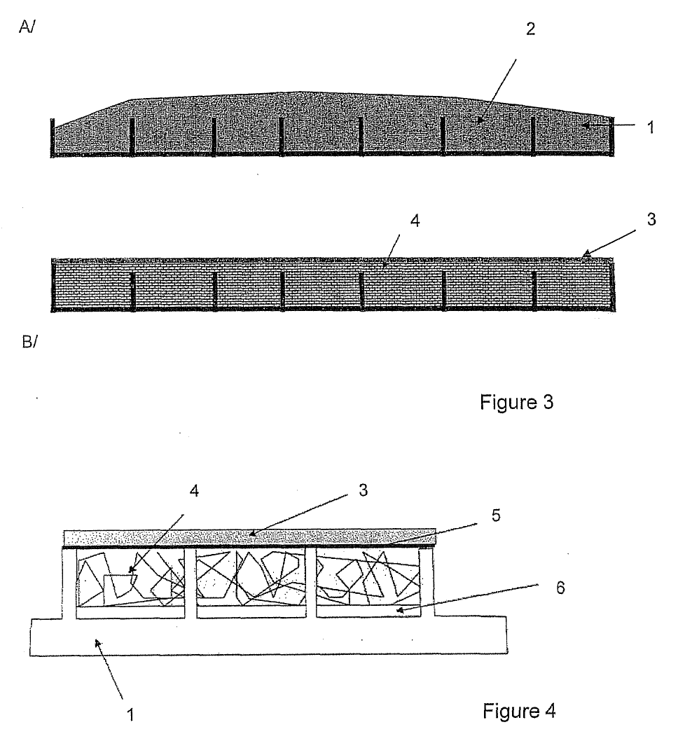

### Filling of the Troughs (FIG. 3A):

To fill the troughs 1, it suffices to deposit drops of the mixture described above 2, by inkjet or by micropipette.

The mixture 2 is deposited in excess. Thus, the liquid crystal may overflow outside the troughs 1 and may cover the top of the walls.

### Placement of the Cover (FIG. 3B):

A cover 3 is then placed on the troughs 1. In the case in which a trough 1 is only partly filled, it is automatically filled during the placement of the cover 3 by the fact that an excess of material 2 exists. On the contrary, in the case in which a trough 1 is overfull, it is automatically emptied into the adjacent troughs during the placement of the cover 3.

The combination is pressed and then insolated with UV light. The mixture is gelled due to the photopolymerization. It converts the reaction mixture to a liquid crystal material having a high adhesive power 4. FIG. 3B illustrates this adhesive anisotropic gel, consisting of a three-dimensional network of polymer filled with liquid crystal.

If, previously, the troughs 1 or the cover 3 are coated with alignment layers and if the material 2, before curing, has a liquid crystal phase, the material obtained after curing 4 is transparent.

### 2/ FABRICATION OF BATTERIES

### Preparation of the Reaction Mixture:

A mixture is prepared comprising by weight:

1% Irgacure 250 (CIBA);

64% of a mixture of LiClO₄ and polyethylene oxide;

5% of compound G (as described above);

30% of compound F (as described above).

The troughs 1 are filled with the mixture of monomer and electrolyte.

### Filling of the Troughs and Placement of the Cover (FIG. 4):

The mixture is insolated under UV irradiation and the UV insolation is then turned off. The seal cover 3, consisting of a metal plate coated with an inorganic layer of the V₂0₅ type 5 and serving as a cathode, is placed on the troughs 1. The lithium cathode 6 has been placed before filling on the bottom of the trough 1, that is opposite the cathode 3.

The curing converts the liquid to a gel 4 and allows the mechanical maintenance of the cover 3 on the troughs 1.

### REFERENCES

(1) R. A. M. HIKMET and J. LUB: “ANISOTROPIC NETWORKS AND GELS OBTAINED BY PHOTOPOLYMERISATION IN THE LIQUID CRYSTALLINE STATE: SYNTHESIS AND APPLICATIONS” Prog. Polym. Sci., Vol. 21, 1165-1209, 1996.
(2) Yun-Hsing FAN, Hongwen REN, and Shin-Tson WU “NORMAL-MODE ANISOTROPIC LIQUID-CRYSTAL GELS” Applied Physics Letters Vol. 82(18), 2945-47,2003.

1. A mixture for fabricating an adhesive gel comprising:
a liquid crystal molecules having optical properties;
liquid crystal monomers, carrying crosslinkable functions, and representing at least 30% by weight of the mixture, advantageously at least 40% by weight.

2. The mixture as claimed in claim 1, wherein the crosslinkable function is an acrylic or epoxy function.

3. The mixture as claimed in claim 1, wherein the mixture further comprises a photoinitiator advantageously Irgacure 651 or lucridine TPO when the crosslinkable function is an acrylic function, or a compound of the photo acid generator type when the crosslinkable function is an epoxy function.

4. The mixture as claimed in claim 1, wherein the crosslinkable functions, carried by the liquid crystal monomers, are of the acrylic type and are located at the ends, advantageously two in number.

5. The mixture as claimed in claim 4, wherein the mixture further comprises a dichroic dye or a photochromic compound.

6. A method for fabricating an adhesive gel, wherein the mixture as claimed in one of claims 1 to 5 is subjected to a curing step, advantageously by insolation with UV light.

7. An adhesive gel obtained using the method as claimed in claim 6.

8. A method for fabricating and sealing crystal-containing cells consisting of juxtaposed cells comprising the following steps:
filling, advantageously to excess, the troughs using a mixture as claimed in one of claims 1 to 5;
placement of a cover;
pressing;
a curing of the mixture, advantageously by insolation with UV.
